(19) United States
(12) Patent Application Publication
(10) Pub. No.: US 2009/0265651 A1
(43) Pub. Date: Oct. 22, 2009

(54) SYSTEM AND METHOD FOR MANAGING A TRAVEL ITINERARY

(76) Inventors: Ronald D. Hodson, Encinitas, CA (US); June Clarke, San Diego, CA (US)

Correspondence Address: CATALYST LAW GROUP, APC, 9710 SCRANTON ROAD, SUITE S-170, SAN DIEGO, CA, 92121, US

(21) Appl. No.: 12/428,403

(22) Filed: Apr. 22, 2009

Related U.S. Application Data
(60) Provisional application No. 61/047,059, filed on Apr. 22, 2008.

(51) Int. Cl. G06F 3/048; G06F 17/00

(52) U.S. Cl. 715/769; 715/234; 715/781

(57) ABSTRACT

User interface showing timed and sequence events interleaved in a travel itinerary is disclosed herein. According to a preferred method of the present invention, the planning begins with a particular day at a destination. Next, ad hoc activities are created as a list in no particular order. Generic activities are also included in the list. A user will then drag the generic and ad hoc activities (bookmarks) that will themselves become either timed bookmarks or sequenced bookmarks. The timed bookmarks have a particular start and end time while the sequenced bookmarks will not have a definite start and end time. Once the planning is completed, the trip information should be shared with others involved in the current trip, as well as others that will plan subsequent related trips.

### RELATED APPLICATION

This patent application contains subject matter claiming, benefit of the priority date of U.S. Provisional Patent Application Ser. No. 61/047,059, filed on Apr. 22, 2008, accordingly, the entire contents of this provisional patent application is hereby expressly incorporated by reference.

### BACKGROUND OF THE INVENTION

1. Field of the Invention

The present invention pertains generally to systems and methods for managing events in a calendar. More specifically, the present invention relates to a web-based user interface for creating and sharing events for a business or vacation itinerary; and thereby assisting in travel planning for subsequent users.

2. Description of the Prior Art

Many people employ software or browser applications to maintain an appointment calendar. Typical examples of such applications are Microsoft Outlook® from Microsoft Corporation, Google Calendar® from Google or iCal® from Apple Computer, Inc.. Various other solutions have been published and one such solution was proposed by Miksovsky, U.S. Pat. App. Pub. No. 2008/0077888, entitled “Calendar Application User Interface with Free-Form Appointment Entry.” While each prior solution appears to meet their respective purposes, current programs force a user to create events with stated beginning and end times even though they may not know or care when some of those times are. Yet further, when any such calendar is shared with other people, the person who created the events may remember which events have placeholder start and end times (so they can show on the calendar), but other people may interpret the start and end times as firm and predictable times rather than, for example, flexible and/or approximate start and end times.

In light of the above, it is an object of the present invention to provide a System and Method for Managing A Travel Itinerary that is simplified over most prior art solutions, but also allows for timed and sequenced events interleaved in single travel itinerary. It is further an object of the present invention to provide a system and method to form the basis for a monetizing website business model. It is yet further an object of the present invention to provide an event calendar that can be saved and shared, subsequent to the day the events occurred, so that others creating, a similar itinerary can review past activities of predecessors. Additionally, a further object of the present invention is to provide System and Method for Managing A Travel Itinerary that is easy to implement, simple to use, and comparatively cost effective.

### BRIEF SUMMARY OF THE INVENTION

The present invention specifically addresses and alleviates the above mentioned deficiencies associated with the prior art. More particularly in a first aspect, the present invention is characterized as a method for managing a travel itinerary aided by a software or a web-based application comprising: providing a plurality of bookmarks representing activities (or events): listing the bookmarks in a first window; dragging the bookmarks from a first window to a second window, and incrementing hours of a day on a left side of the second window, wherein the dragged bookmarks are represented as either timed bookmarks or sequenced bookmarks, and wherein the timed bookmarks are represented on the left side of the second window adjacent to the hours or the day, and wherein the sequenced bookmarks are represented on a right side of the second window. It shall be readily apparent to one of ordinary skill in the art that right and left sides herein may be reversed.

Additionally, the method of the present invention is characterized in that providing bookmarks representing activities comprises: providing generic bookmarks; and creating ad hoc activities representing real places and real things to do. Among other icons, the generic bookmarks are icons comprising: a plane icon, a taxi icon, a bus icon, a rail icon, a meal icon, a drink icon, a leisure icon, and a sleep icon. Further, the first and second windows together represent one day of the itinerary.

Importantly, the method further comprises sharing a first itinerary of a first user with second and subsequent users, wherein the sharing further comprises sharing with the second and subsequent users on a current trip and sharing with second and subsequent users on second and later trips to a common destination. The method is further characterized by the step of interleaving the timed and sequenced bookmarks. Also, an itinerary date is provided above the second window; and a specific itinerary destination is provided above the itinerary date.

In a second aspect, the present invention may be characterized as a user interface for managing a travel itinerary comprising: a first window for listing bookmarks, the bookmarks including generic and ad hoc bookmarks; a second window for planning events that occur during a day, the events including timed bookmarks and sequenced bookmarks, wherein the timed bookmarks have an assigned start time and an assigned end time, and wherein the sequenced bookmarks do not have an assigned start time and assigned end time.

The user interface of the present invention may be additionally characterized in that the second window further comprises increments representing a time of the day on a left side of the second window, wherein the timed bookmarks are shown on the left side adjacent to the increments representing the time of the day, and the sequenced bookmarks are shown on a right side of the second window. The user interface is additionally characterized wherein the generic and ad hoc bookmarks are dragged from the first window to the second window, and wherein a user chooses whether to make said generic and ad hoc bookmarks either a timed bookmark or a sequenced bookmark. Optionally, the user interface could offer approximate start and end times for the sequenced events.

In a third aspect, the present invention is characterized as a method for managing a travel itinerary aided by a software or a web-based application comprising: providing a plurality of bookmarks representing activities (or events); incrementing hours of a day on a left side of a window, wherein the bookmarks are represented as either timed bookmarks or sequenced bookmarks, wherein the timed bookmarks are represented on the left side of the window adjacent to the hours or the day, and wherein the sequenced bookmarks are represented on a right side of the window; and sharing a first itinerary of a first user with second and subsequent users, wherein the sharing further comprises sharing with the second and subsequent users on a current trip and sharing with second and subsequent users on second and later trips to a common destination. Further, the providing bookmarks representing activities comprises providing generic bookmarks; and creating ad hoc activities representing real places and real things to do.

These, as well as other advantages of the present invention will be more apparent from the following description and drawings. It is understood that changes in the specific structure shown and described may be made within the scope of the claims, without departing from the spirit of the invention.

While the apparatus and method has or will be described for the sake of grammatical fluidity with functional explanations, it is to be expressly understood that the claims, unless expressly formulated under 35 USC 112, are not to be construed as necessarily limited in any way by the construction of “means” or “steps”, limitations, but are to be accorded the full scope of the meaning and equivalents of the definition provided by the claims under the judicial doctrine of equivalents, and in the case where the claims are expressly formulated under 35 USC 112 are to be accorded full statutory equivalents under 35 USC 112.

The invention can be better visualized by turning now to the following drawings wherein like elements are expressed using like reference characters.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a schematical illustration of an exemplary graphical user interface of the present invention configured for either a software application or a web-based application; and

FIG. 2 is functional block diagram of an exemplary method of the present invention.

### DETAILED DESCRIPTION OF DRAWINGS

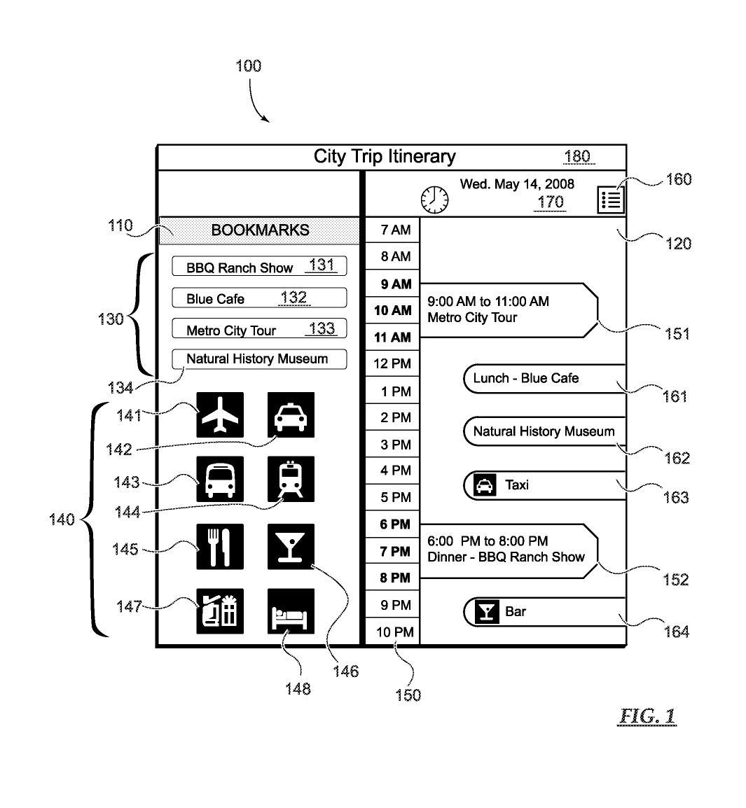

Referring initially to the FIG. 1, the present invention 100 relates to the various aspects for creating and changing a travel itinerary that combines timed 150 and sequenced events 160, also called bookmarks 110 herein.

Initially, the objects to be added to the itinerary are bookmarks 130 representing real places or things to do (e.g. lunch at Blue Café 132, or take Metro City Tour 133), or generic icons 140 that represent various potential activities or actions. From here on the use of the term bookmarks 110 will mean both ad hoc bookmarks 130 and generic icons 140.

Upon creating and listing ad hoc activities 130, the bookmarks 110 can be dragged into a separate planning calendar window 120, which has hours of the day incrementing 150 vertically along the left side of the window, and no information along the right. Once the user drags the bookmark 110 into the window 120, they can adhere the bookmark to the left side of the window if it is a timed event 151, 152 or to the right side of the window if it is a sequenced event 161, 162, 163, 164. Events 110 can be interleaved, or arranged in alternating fashion, or not interleaved.

Also accordingly to a preferred embodiment of the present invention, the bookmarks 151, 152, 161, 162, 163, 164 can be dragged from the left side to the right side (and vice versa) of the second window 120 if the user decides to change from a timed event 150 to a sequenced event 160 (or vice versa). For timed bookmarks 150, their start and end times can be edited, sequenced bookmarks 160 can be moved to appear in a different order, and both kinds of bookmarks can be interleaved in various combinations.

Generic icons 140 among the List of bookmarks in the first window 110 may be for example: a plane icon 141, a taxi icon 142, a bus icon 143, a rail icon 144, a meal icon 145, a drink icon 146, a leisure icon 147, and a sleep icon 148. Further, the first 110 and second windows 120 together represent one day 170 of the itinerary 100. The user interface 100 also includes a clock icon above the time increments 150 for timed bookmarks 151, 152 and a sequencing icon 160 is provided above the second window 120 on the right side above the sequenced bookmarks 161, 162, 163, 164.

Importantly, the bookmarks 110 are able to be dragged 210 around as objects in a user friendly manner. Still further, sharing 299 of past itineraries is important because subsequent travelers will want to know what their predecessors 230 did during their business or vacation travel.

In this way among others, the present invention 100 provides a monetizing website business model. It is further contemplated that approximate times and durations could be added to sequenced bookmarks 160. Yet further, the present invention is applicable to time management software and general events calendars.

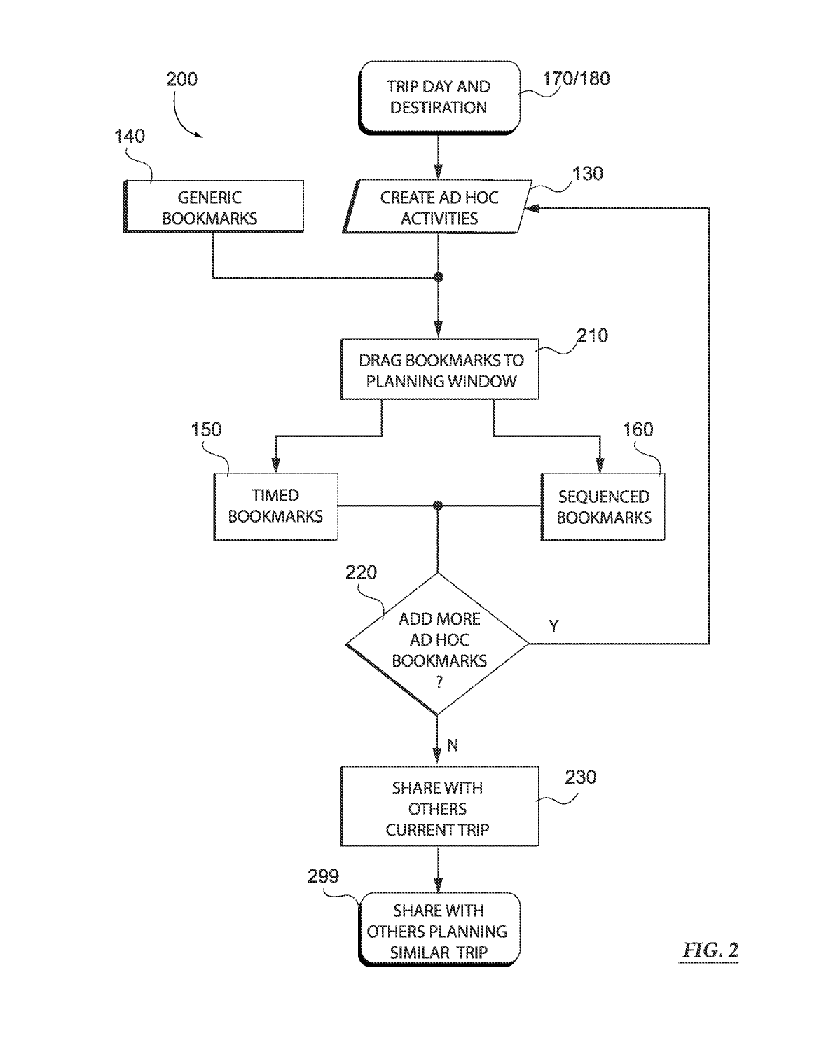

Referring to FIG. 2, a functional block diagram of a method 200 of the present invention is illustrated. At the outset, a day 170 and destination 180 are noted. Next, ad hoc activities 120 are created as a list in no particular order. Also. the generic bookmarks 140 are included in the list 110. A user will then drag 210 and interleave the generic 140 and ad hoc 130 bookmarks that will themselves become either timed bookmarks 150 or sequenced bookmarks 160. This will comprise the core of the planning being performed by a user. More ad hoc bookmarks 130 may be created 220 during the trip planning. And as stated, it is contemplated that the information displayed herein should be shared with others involved in the current trip 230, as well as others that will plan subsequent related trips 299.

While the particular System and Method for Managing A Travel Itinerary as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

1. A method for managing a travel itinerary aided by a software or a web-based application comprising:
providing a plurality of bookmarks representing activities (or events);
listing the bookmarks in a first window;
dragging the bookmarks from a first window to a second window; and
incrementing hours of a day on a left side of the second window, wherein the dragged bookmarks are represented as either timed bookmarks or sequenced bookmarks, wherein the timed bookmarks are represented on the left side of the second window adjacent to the hours or the day, and wherein the sequenced bookmarks are represented on a right side of the second window.
